(19) United States
(12) Patent Application Publication
(10) Pub. No.: US 2014/0358303 A1
(43) Pub. Date: Dec. 4, 2014

(54) Method and Apparatus for Stabilizing Pressure in an Intelligent Regulator Assembly

(71) Applicant: TESCOM CORPORATION, Elk River, MN (US)

(72) Inventor: Christian Leonard, Hanover (DE)

(73) Assignee: TESCOM CORPORATION, Elk River, MN (US)

(21) Appl. No.: 14/277,928

(22) Filed: May 15, 2014

Related U.S. Application Data
(60) Provisional application No. 61/830,538, filed on Jun. 3, 2013.

(51) Int. Cl. G05D 7/06

(52) U.S. Cl. CPC G05D 7/0629
USPC 700/283

(57) ABSTRACT

A method of stabilizing pressure in an intelligent regulator assembly is provided. The method includes receiving, at an on-board controller of a pilot device, a request to activate a suspend control mode. The method also includes activating, via the on-board controller, the suspend control mode. The activation of the suspend control mode includes adjusting an inlet valve and an exhaust valve of the pilot device, and suspending control of the inlet valve and the exhaust valve.

### CROSS-REFERENCE TO RELATED APPLICATIONS

The priority benefit of U.S. Provisional Patent Application No. 61/830,538, filed Jun. 3, 2013, is hereby claimed and the entire contents thereof are incorporated herein by reference.

### FIELD OF THE DISCLOSURE

The present disclosure is directed to process control systems and, more particularly, field devices such as pressure regulators and pilot loading mechanisms for pressure regulators used in process control systems.

### BACKGROUND

Process control systems, such as distributed or scalable process control systems like those used in chemical, petroleum or other processes, typically include one or more process controllers communicatively coupled to one or more field devices via analog, digital or combined analog/digital buses. The field devices, which may include, for example, control valves, valve positioners, switches and transmitters (e.g., temperature, pressure and flow rate sensors), perform functions within the process such as opening or closing valves and measuring process parameters. The process controller receives signals indicative of process measurements made by the field devices and/or other information pertaining to the field devices, and uses this information to execute or implement one or more control routines to generate control signals, which are sent over the buses to the field devices to control the operation of the process. Information from each of the field devices and the controller is typically made available to one or more applications executed by one or more other hardware devices, such as host or user workstations, personal computers or computing devices, to enable an operator to perform any desired function regarding the process, such as setting parameters for the process, viewing the current state of the process, modifying the operation of the process, etc.

In some situations, such as when leak testing or sensor calibration is to be performed, pressure levels may need to be stabilized and/or reduced to zero in the process control system. Additional valves and supporting input and output lines may thus be installed in the processor control system. For example, additional valves may be installed on the end(s) of pipelines or vessels in the process control system. In turn, one or more of the field devices are no effectively longer controlled. This prevents pressure fluctuations, which would normally occur as a result of the field devices being controlled, thereby achieving the desired goal of stabilizing pressure levels, and/or reducing them to zero, in the process control system.

### SUMMARY

One aspect of the present disclosure includes a method of stabilizing pressure in an intelligent regulator assembly having a pilot device and a regulator. The pilot device includes an inlet port coupled to a source of supply pressure and having an inlet valve, an exhaust port having an exhaust valve, an outlet port configured to output a controlled pressure to the regulator, and an on-board controller communicatively coupled to the inlet valve and the exhaust valve. The on-board controller is operable to control the inlet valve and the exhaust valve to control the pressure delivered to the regulator. The on-board controller includes a memory, a processor, and logic stored on the memory. The method includes receiving, at the on-board controller, a request to activate a suspend control mode. The method also includes activating, via the on-board controller, the suspend control mode, the activating including adjusting the inlet valve and the exhaust valve, and suspending control of the inlet valve and the exhaust valve.

### BRIEF DESCRIPTION OF THE DRAWINGS

FIG. 1 is a schematic representation of a process control system having one or more pilot devices constructed in accordance with the principles of the present disclosure.

FIG. 2 is a cross-sectional side view of one version of an intelligent regulator assembly constructed in accordance with the principles of the present disclosure.

FIG. 3 is a block diagram of one version of a pilot device of the intelligent regulator assembly shown in FIG. 2.

FIG. 4 is a block diagram of one version of a personal computing device of the intelligent regulator assembly shown in FIG. 2.

FIG. 5 is a process flow chart showing one version of a method for stabilizing pressure in an intelligent regulator assembly in accordance with the present disclosure.

### DETAILED DESCRIPTION

The present disclosure is directed to an intelligent regulator assembly having an pilot device, which can be a field device of a process control system, for example. More specifically, the pilot device provides a suspend control mode that is beneficial for applications in which total pressure stability is required.

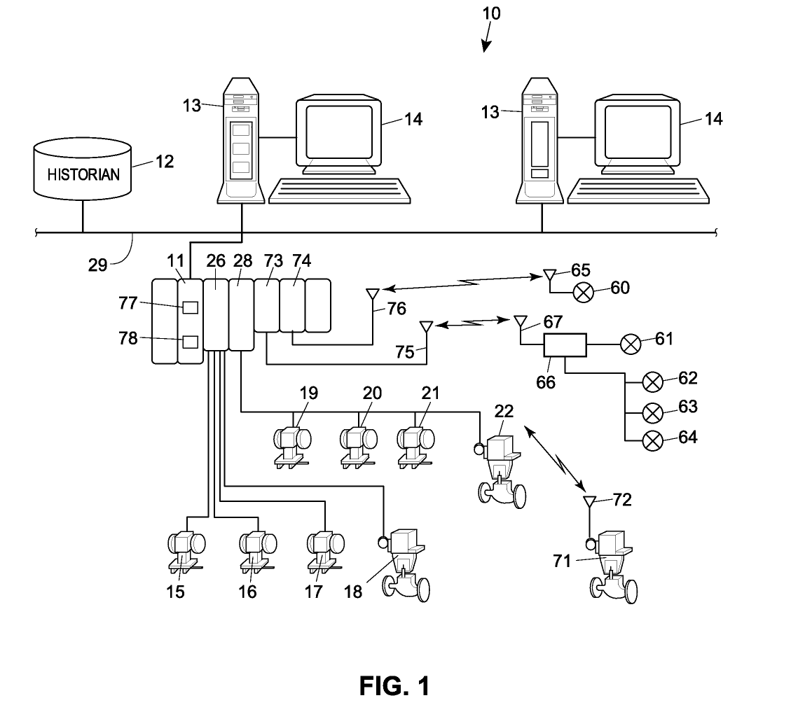

Referring now to FIG. 1, a process control system 10 constructed in accordance with one version of the present disclosure is depicted incorporating one or more field devices 15, 16, 17, 18, 19, 20, 21, 22, and 71 in communication with a process controller 11, which in turn, is in communication with a data historian 12 and one or more user workstations 13, each having a display screen 14. So configured, the controller 11 delivers signals to and receives signals from the field devices 15, 16, 17, 18, 19, 20, 21, 22, and 71 and the workstations 13 to control the process control system.

In additional detail, the process controller 11 of the process control system 10 of the version depicted in FIG. 1 is connected via hardwired communication connections to field devices 15, 16, 17, 18, 19, 20, 21, and 22 via input/output (I/O) cards 26 and 28. The data historian 12 may be any desired type of data collection unit having any desired type of memory and any desired or known software, hardware or firmware for storing data. Moreover, while the data historian 12 is illustrated as a separate device in FIG. 1, it may instead or in addition be part of one of the workstations 13 or another computer device, such as a server. The controller 11, which may be, by way of example, a DeltaV™ controller sold by Emerson Process Management, is communicatively connected to the workstations 13 and to the data historian 12 via a communication network 29 which may be, for example, an Ethernet connection.

As mentioned, the controller 11 is illustrated as being communicatively connected to the field devices 15, 16, 17, 18, 19, 20, 21, and 22 using a hardwired communication scheme which may include the use of any desired hardware, software and/or firmware to implement hardwired communications, including, for example, standard 4-20 mA communications, and/or any communications using any smart communication protocol such as the FOUNDATION® Fieldbus communication protocol, the HART® communication protocol, etc. The field devices 15, 16, 17, 18, 19, 20, 21, and 22 may be any types of devices, such as sensors, control valve assemblies, transmitters, positioners, etc., while the I/O cards 26 and 28 may be any types of I/O devices conforming to any desired communication or controller protocol. In the embodiment illustrated in FIG. 1, the field devices 15, 16, 17, 18 are standard 4-20 mA devices that communicate over analog lines to the I/O card 26, while the digital field devices 19, 20, 21, 22 can be smart devices, such as HART® communicating devices and Fieldbus field devices, that communicate over a digital bus to the I/O card 28 using Fieldbus protocol communications. Of course, the field devices 15, 16, 17, 18, 19, 20, 21, and 22 may conform to any other desired standard(s) or protocols, including any standards or protocols developed in the future.

In addition, the process control system 10 depicted in FIG. 1 includes a number of wireless field devices 60, 61, 62, 63, 64 and 71 disposed in the plant to be controlled. The field devices 60, 61, 62, 63, 64 are depicted as transmitters (e.g., process variable sensors) while the field device 71 is depicted as a control valve assembly including, for example, a control valve and an actuator. Wireless communications may be established between the controller 11 and the field devices 60, 61, 62, 63, 64 and 71 using any desired wireless communication equipment, including hardware, software, firmware, or any combination thereof now known or later developed. In the version illustrated in FIG. 1, an antenna 65 is coupled to and is dedicated to perform wireless communications for the transmitter 60, while a wireless router or other module 66 having an antenna 67 is coupled to collectively handle wireless communications for the transmitters 61, 62, 63, and 64. Likewise, an antenna 72 is coupled to the control valve assembly 71 to perform wireless communications for the control valve assembly 71. The field devices or associated hardware 60, 61, 62, 63, 64, 66 and 71 may implement protocol stack operations used by an appropriate wireless communication protocol to receive, decode, route, encode and send wireless signals via the antennas 65, 67 and 72 to implement wireless communications between the process controller 11 and the transmitters 60, 61, 62, 63, 64 and the control valve assembly 71.

If desired, the transmitters 60, 61, 62, 63, 64 can constitute the sole link between various process sensors (transmitters) and the process controller 11 and, as such, are relied upon to send accurate signals to the controller 11 to ensure that process performance is not compromised. The transmitters 60, 61, 62, 63, 64, often referred to as process variable transmitters (PVTs), therefore may play a significant role in the control of the overall control process. Additionally, the control valve assembly 71 may provide measurements made by sensors within the control valve assembly 71 or may provide other data generated by or computed by the control valve assembly 71 to the controller 11 as part of its operation. Of course, as is known, the control valve assembly 71 may also receive control signals from the controller 11 to effect physical parameters, e.g., flow, within the overall process.

The process controller 11 is coupled to one or more I/O devices 73 and 74, each connected to a respective antenna 75 and 76, and these I/O devices and antennas 73, 74, 75, 76 operate as transmitters/receivers to perform wireless communications with the wireless field devices 61, 62, 63, 64 and 71 via one or more wireless communication networks. The wireless communications between the field devices (e.g., the transmitters 60, 61, 62, 63, 64 and the control valve assembly 71) may be performed using one or more known wireless communication protocols, such as the WirelessHART® protocol, the Ember protocol, a WiFi protocol, an IEEE wireless standard, etc. Still further, the I/O devices 73 and 74 may implement protocol stack operations used by these communication protocols to receive, decode, route, encode and send wireless signals via the antennas 75 and 76 to implement wireless communications between the controller 11 and the transmitters 60, 61, 62, 63, 64 and the control valve assembly 71.

As illustrated in FIG. 1, the controller 11 conventionally includes a processor 77 that implements or oversees one or more process control routines (or any module, block, or sub-routine thereof) stored in a memory 78. The process control routines stored in the memory 78 may include or be associated with control loops being implemented within the process plant. Generally speaking, and as is generally known, the process controller 11 executes one or more control routines and communicates with the field devices 15, 16, 17, 18, 19, 20, 21, 22, 60, 61, 62, 63, 64, and 71, the user workstations 13 and the data historian 12 to control a process in any desired manner(s). Additionally, any one of the field devices 18, 22, and 71 in FIG. 1, each of which is depicted as a control valve assembly, can include an intelligent control valve actuator constructed in accordance with the principles of the present disclosure for communicating with the process controller 11 in order to facilitate monitoring of the actuator's health and integrity.

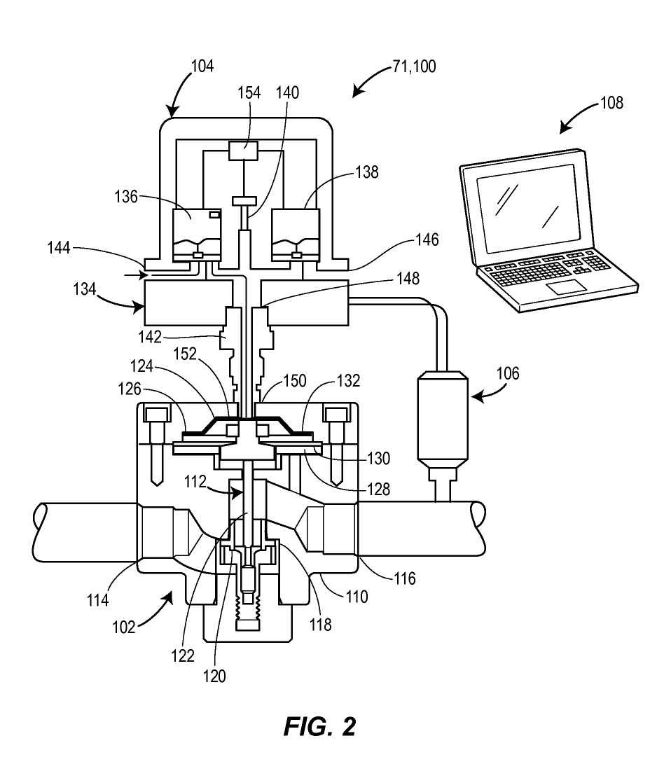

Referring now to FIG. 2, for the sake of description, field device 71 from FIG. 1 is shown as an intelligent regulator assembly 100 constructed in accordance with the principles of the present disclosure. In FIG. 2, the intelligent regulator assembly 100 includes a regulator 102, a pilot device 104, and a feedback pressure sensor 106. Additionally, FIG. 2 depicts an optional personal computing device 108 communicatively coupled to the pilot device 104 to enable user interaction with the pilot device 104, as will be described.

The regulator 102 includes a valve body 110 and a control assembly 112. The valve body 110 defines an inlet 114, an outlet 116, and a gallery 118 defining a seating surface 120. The control assembly 112 is carried within the valve body 110 and includes a control element 122 operably connected to a diaphragm assembly 124. The control element 122 is movable between a closed position in sealing engagement with the seating surface 120 and an open position spaced away from the seating surface 120 in response to pressure changes across the diaphragm assembly 124. As depicted, the diaphragm assembly 124 includes a diaphragm 126 disposed within a diaphragm cavity 128 of the valve body 110 of the regulator 102. A bottom surface 130 of the diaphragm 126 is in fluid communication with the outlet 116 of the valve body 110 and a top surface 132 of the diaphragm 126 is in fluid communication with the pilot device 104 via a pilot opening 150 in the valve body 110.

The pilot device 104 includes a valve body 134, an inlet valve 136, an exhaust valve 138, a pressure sensor 140, and an outlet adaptor 142. The valve body 134 defines an inlet port 144, an exhaust port 146, and an outlet port 148. The inlet port 144 is adapted to be connected to a source of supply gas for loading the dome 152 of the regulator 102, as will be described. As depicted, the inlet valve 136 is disposed adjacent to the inlet port 144, the exhaust valve 138 is disposed adjacent to the exhaust port 146, and the outlet adaptor 142 extends from the outlet port 148 and to the pilot opening 150 in the valve body 110. Thus, the outlet adaptor provides 142 fluid communication between the pilot device 104 and the regulator 102. The pressure sensor 140 is disposed in the valve body 134 of the pilot device 104 at a location between the inlet and outlet valves 136, 138. As such, the pressure sensor 140 is operable to sense the pressure between the inlet and outlet valves 136, 138, as well as in the outlet port 148, the outlet adaptor 142, and the diaphragm cavity 128 adjacent to the top surface 132 of the diaphragm 126. This portion of the diaphragm cavity 128 can be referred to as the dome 152 of the regulator 102. In one version of the pilot device 104 the inlet and exhaust valves 136, 138 can be solenoid valves such as Pulse Width Modulation (PWM) solenoid valves and the pressure sensor 104 can be a pressure transducer. Moreover, the inlet and exhaust valves 136, 138 and the pressure sensor 140 can be communicatively coupled to an on-board controller 154, which can store logic and/or direct some or all of the functionality of the pilot device 104, as will be described below.

Still referring to FIG. 2, the feedback pressure sensor 106 of the assembly 100 includes a pressure transducer arranged to detect the pressure at the outlet 116 of the regulator 102 and transmit signals to the pilot device 104 and, more particularly, to the on-board controller 154 of the pilot device 104. Based on the signals received by the on-board controller 154 from the feedback pressure sensor 106, the pilot device 104 opens and/or closes the inlet and exhaust valves 136, 138 to control the pressure in the dome 152 of the regulator 102, which in turn, controls the position of the control element 122 and ultimately the pressure at the outlet 116 of the regulator 102.

Specifically, during normal operation, the pressure at the outlet 116 of the regulator 102 is controlled and maintained as desired by adjusting the pressure in the dome 152 of the regulator 102. This is achieved via operation of the pilot device 104 and feedback pressure sensor 106. For example, in one version, the feedback pressure sensor 106 detects the pressure at the outlet 116 every 25 milliseconds and transmits a signal to the on-board controller 154 of the pilot device 104. The on-board controller 154 compares this signal, which is indicative of the pressure at the outlet 116, to a desired set-point pressure and determines if the outlet pressure is less than, equal to, or greater than the set-point pressure. Based on this determination, the pilot device 104 manipulates either or both of the inlet and exhaust valves 136, 138 to adjust the pressure in the dome 152. That is, if the sensed outlet pressure is lower than the desired set-point pressure, the on-board controller 154 activates the inlet valve 136 (e.g., instructs the inlet valve 136 to open and the exhaust valve 138 to close). In this configuration, gas enters the inlet port 144 of the pilot device 104 and increases the pressure in the dome 152, which causes the diaphragm assembly 124 to urge the control element 122 downward relative to the orientation of FIG. 2, which opens the regulator 102 and increases flow and ultimately pressure at the outlet 116. In contrast, if the pressure sensed at the outlet 116 by the feedback pressure sensor 106 is determined to be higher than the desired set-point pressure, the on-board controller 154 activates the exhaust valve 138 (e.g., instructs the exhaust valve 138 to open and the inlet valve 136 to close). In this configuration, gas in the dome 152 exhausts out through the exhaust port 146 of the pilot device 104 to decrease the pressure on the top surface 132 of the diaphragm 126. This allows the outlet pressure to urge the diaphragm assembly 124 and control element 122 upward relative to the orientation of FIG. 2, which closes the regulator 102 and decreases flow and ultimately pressure at the outlet 116.

Based on the foregoing description, it should be appreciated that the pilot device 104 and the feedback pressure sensor 106 operate in combination with each other to intermittently, yet frequently, monitor the pressure at the outlet 116 of the regulator 102 and adjust the pressure in the dome 152 until the pressure at the outlet 116 is equal to the set-point pressure.

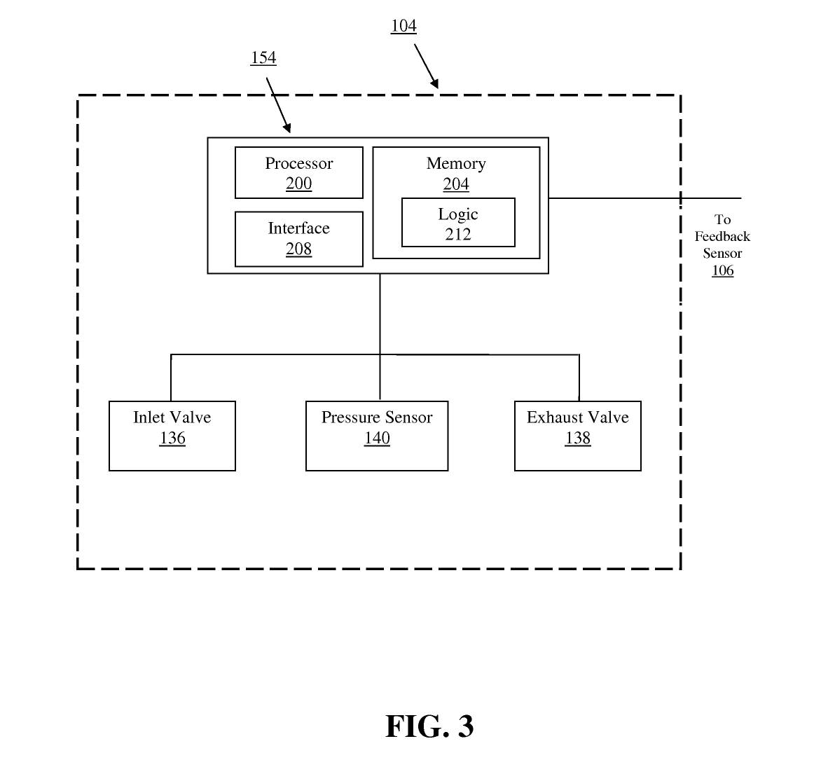

With reference to FIG. 3, the on-board controller 154 may include a processor 200, a memory 204, a communications interface 208, and computing logic 212. The processor 200 may be a general processor, a digital signal processor, ASIC, field programmable gate array, graphics processing unit, analog circuit, digital circuit, or any other known or later developed processor. The processor 200 operates pursuant to instructions in the memory 204. The memory 204 may be a volatile memory or a non-volatile memory. The memory 204 may include one or more of a read-only memory (ROM), random-access memory (RAM), a flash memory, an electronic erasable program read-only memory (EEPROM), or other type of memory. The memory 204 may include an optical, magnetic (hard drive), or any other form of data storage device.

The communications interface 208, which may be, for example, a universal serial bus (USB) port, an Ethernet port, or some other port or interface, is provided to enable or facilitate electronic communication between the pilot device 104 and the computing device 108. This electronic communication may occur via any known method, including, by way of example, USB, RS-232, RS-485, WiFi, Bluetooth, or any other suitable communication connection.

The logic 212 includes one or more routines and/or one or more sub-routines, embodied as computer-readable instructions stored on the memory 204. The pilot device 104, particularly the processor 200, may execute the logic 212 to cause the processor 200 to perform actions related to the configuration, management, maintenance, diagnosis, and/or operation of the pilot device 104. The logic 212 may, when executed, cause the processor 200 to receive and/or obtain signals or requests from the personal computing device 108, determine the contents of any received and/or obtained signals or requests, monitor the pressure detected by the pressure sensor 140, open and/or close the inlet and/or exhaust valves 136, 138, suspend control of the opened and/or closed inlet and/or exhaust valves 136, 138, and/or perform other desired functionality.

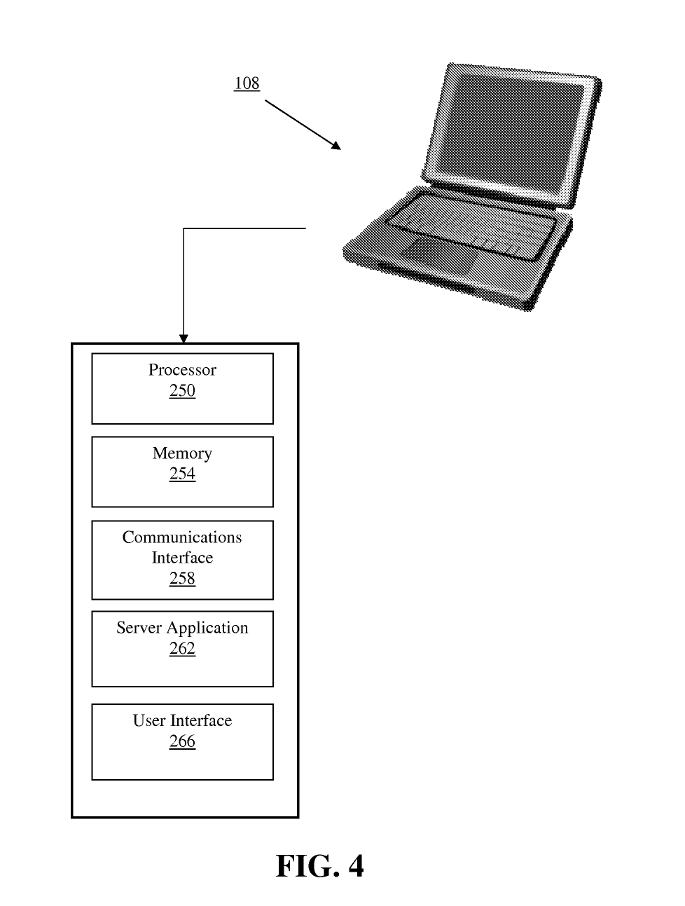

Turning to FIG. 4, further details of the personal computing device 108 will now be described. The personal computing device 108 may be a desktop computer, a notebook computer, a user workstation, a tablet, a hand held computing device (e.g., a smart phone), or other personal computing device. In one embodiment, the personal computing device 108 is the same as the user workstation 13 described in connection with FIG. 1.

As shown in FIG. 4, the personal computing device 108 includes a processor 250, a memory 254, a communications interface 258, and an application 262. The processor 250 may be a general processor, a digital signal processor, ASIC, field programmable gate array, graphics processing unit, analog circuit, digital circuit, or any other known or later developed processor. The processor 250 operates pursuant to instructions in the memory 254. The memory 254 may be a volatile memory or a non-volatile memory. The memory 254 may include one or more of a read-only memory (ROM), random-access memory (RAM), a flash memory, an electronic erasable program read-only memory (EEPROM), or other type of memory. The memory 254 may include an optical, magnetic (hard drive), or any other form of data storage device.

The communications interface 258, which may be, for example, a universal serial bus (USB) port, an Ethernet port, or some other port or interface, is provided to enable or facilitate electronic communication between the personal computing device 108 and the pilot device 104. This electronic communication may occur via any known method, including, by way of example, USB, RS-232, RS-485, WiFi, Bluetooth, or any other suitable communication connection.

The application 262 includes computing logic, such as one or more routines and/or one or more sub-routines, embodied as computer-readable instructions stored on the memory 254 or another memory. The personal computing device 108, particularly the processor 250, may execute the logic to cause the processor 250 to perform actions related to the configuration, management, maintenance, diagnosis, and/or operation (e.g., control or adjustment) of the components of the assembly 100 (e.g., the pilot device 104). The application 262 may facilitate automatic interaction and/or manual interaction with the pilot device 104. For example, the application 262 may facilitate performance of an automated tuning procedure on the pilot device 104. The application 262 may facilitate manual interaction for a user of the personal computing device 108 with the pilot device 104. To this end, the application may include or provide the user with a user interface 266 that facilitates user interaction with (e.g., control of) the pilot device 104.

With or via the user interface 266, the user may select or request activation of a suspend control mode in which control of the other components of the assembly 100 (e.g., the regulator 102) by the pilot device 104 is suspended, as will be described in greater detail below. The user may also utilize the user interface 266 to manually tune the pilot device 104, program a set point of the pilot device 104, adjust proportional, derivative, and/or integral values and/or integral limits and/or dead band parameters, set control modes, perform calibration, set control limits, set diaphragm protection values, run diagnostic procedures (e.g., a solenoid leak test), and the like.

As described above, during normal operation of the assembly 100, the pressure at the outlet port 148, and, in turn, the pressure in the dome 152, is controlled (e.g., adjusted) based on the set-point pressure and the determined pressure at the outlet 116 of the regulator 102. When, for example, the on-board controller 154 determines that the set-point pressure is higher than the pressure at the outlet 116, such that the pressure at the outlet port 148 and the pressure in the dome 152 needs to be increased, the on-board controller 154 activates the inlet valve 136. In turn, gas enters the inlet port 144 of the pilot device 104, the pressure at the outlet port 148 and in the dome 152 increases, and, ultimately, the pressure at the outlet 116 increases. When, however, the on-board controller 154 determines that the set-point pressure is lower than the pressure at the outlet 116, such that the pressure at the outlet port 148 and the pressure in the dome 152 needs to be increased, the on-board controller 154 activates the exhaust valve 138. In turn, gas in the dome 152 exhausts out through the exhaust port 146 of the pilot device 104, decreasing the pressure at the outlet port 148 and in the dome 152, and, ultimately, the pressure at the outlet 116 decreases. Such a process is iteratively and continuously performed.

In some situations, however, pressure stability in the assembly 100 may be desirable. In other words, in some situations, the changes or fluctuations in pressure (at the outlet port 148, in the dome 152, at the outlet 116, etc.) inherent in the normal operation described above may not be desirable. Pressure stability may, for example, be desirable when an operator of the assembly 100 is conducting or performing a leak test, calibrating a sensor, or performing some other task that requires pressure stability in the assembly 100. By, for example, stabilizing the pressure in the assembly, and monitoring the pressure levels subsequent to this stabilization, the operator can determine whether any components of the assembly 100 are leaking or otherwise faulty. If, for example, the pressure levels are stabilized, but the pressure at the outlet 116 has decreased, the operator may deduce that there are one or more leaks in the assembly 100.

The present embodiments aim to achieve this pressure stability by providing a suspend control mode that, when activated or initiated, disrupts (e.g., suspends, freezes, or stops) the normal process described above. When the suspend control mode is activated, the control algorithm (e.g., the PID algorithm) run or employed by the pilot device 104 is suspended, frozen, or stopped. In other words, when the suspend control mode is activated, the on-board controller 154 stops controlling (e.g., adjusting) the components of the pilot device 104, such as, for example, the inlet valve 136 and/or the exhaust valve 138. Since the on-board controller 154 can no longer control the valves 136, 138, the pilot device 104 is, in essence, no longer responsive to (i.e., the pilot device 104 essentially ignores) the other components of the assembly 100 (e.g., the feedback sensor 106), such that the feedback loop is effectively stopped and, in turn, the pressure values in the assembly 100 are frozen, locked, or maintained.

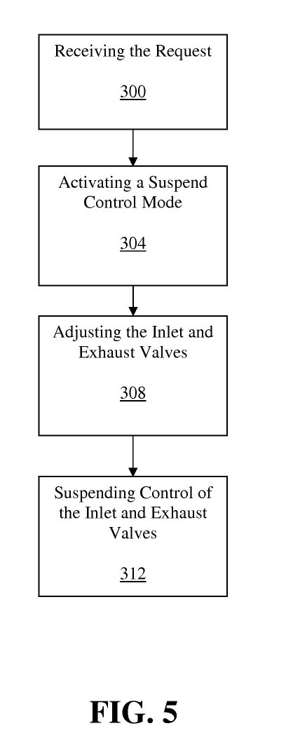

FIG. 5 depicts an exemplary method or process of stabilizing or maintaining the pressure in the assembly 100. The on-board controller 154 of the pilot device 104 first receives a request from the personal computing device 108 via, for example, the communications interface 258 (block 300). The request may be a request to stabilize or freeze the pressure in the assembly 100, or, in other words, a request to activate the suspend control mode. The request may be automatically generated by the computing device 108 or may be generated by the user of the personal computing device 108 using, for example, the user interface 266 of the application 262, and then transmitted from the computing device 108 to the on-board controller 154 of the pilot device 104.

In other embodiments, the on-board controller 154 may receive the request from another computing device (e.g., the controller 11) or the request may be received locally (i.e., entered directly into or on the pilot device 104). Further yet, the on-board controller 154 may, instead of receiving the request, receive data (e.g., a signal) indicative of a leak testing, sensor calibration, or some other activity requiring pressure stabilization, from which the on-board controller 154 may infer the request.

Based on (e.g., in response to) the received request, the on-board controller 154 activates or initiates the suspend control mode (block 304). When activated, the suspend control mode generally involves the on-board controller 154 adjusting the inlet valve 136 and the exhaust valve 138 (block 308) and then suspending control of the adjusted inlet valve 136 and the exhaust valve 138 (block 312).

In some embodiments, the suspend control mode involves the on-board controller 154 closing the inlet valve 136, closing the exhaust valve 138, and suspending control of the closed inlet valve 136 and the closed exhaust valve 138. Since the inlet valve 136 and the exhaust valve 138 are closed, no gas can enter the inlet port 144 of the pilot device 104 and no gas in the dome 152 can be exhausted out through the exhaust port 146 of the pilot device 104. Moreover, because the on-board controller 154 has suspended control of the closed valves 136, 138, the valves 136, 138 cannot be controlled (i.e., opened). In turn, the pressure in the assembly 100, particularly the pressure at the outlet port 148, in the dome 152, and at the outlet 116 of the regulator 102, is frozen, maintained, or held constant. This happens in spite of any information or data received from other components of the assembly 100. For example, the on-board controller 154 may continue to receive feedback information from the pressure sensor 106. However, because the on-board controller 154 is operating in the suspend control mode, the on-board controller 154 will not respond to this feedback information as it normally would.

In other embodiments, the suspend control mode may involve the on-board controller 154 adjusting the inlet valve 136 and/or the exhaust valve 138 in some other way. For example, the on-board controller 154 may close the inlet valve 136, open the exhaust valve 138, and then suspend control of the closed inlet valve 136 and the open exhaust valve 138.

So long as it is desirable to maintain or freeze the pressure in the assembly 100, particularly the pressure at the outlet port 148, in the dome 152, and at the outlet 116 of the regulator 102, the pilot device 104, particularly the on-board controller 154, may continue running or operating in the suspend control mode. The pilot device 104 may operate in the suspend control mode for any length of time (e.g., 30 minutes, 1 day, etc.), depending on the task that is being performed (e.g., sensor calibration, leak testing).

When it is no longer necessary or desirable to maintain or freeze the pressure in the assembly 100, the suspend control mode may be deactivated. The suspend control mode may be deactivated in a manner similar to how the suspend control mode was activated. In turn, the assembly 100, particularly the pilot device 104, may return to a normal operation.

Based on the foregoing description, it should be appreciated that the devices and methods described herein provide for a suspend control feature that is highly advantageous for applications, such as leak detection or sensor calibration, in which total stability, particularly pressure stability, is critical. By providing such a feature without requiring the installation of additional valves and supporting input and output lines for those valves, the disclosed devices and methods are simpler to install and utilize, more reliable, and may have a longer useful life than known process control systems.

1. A pilot device for use with a fluid regulator assembly comprising a fluid regulator and a feedback pressure sensor, the pilot device comprising:
an inlet port coupled to a source of supply pressure and having an inlet valve;
an exhaust port having an exhaust valve;
an outlet port configured to output a controlled pressure to the fluid regulator; and
an on-board controller communicatively coupled to the inlet valve and the exhaust valve and operable to control the inlet valve and the exhaust valve to control the pressure delivered to the fluid regulator, the on-board controller including a memory, a processor, and logic stored on the memory, wherein the logic stored on the memory of the controller is executable by the processor to receive a request to activate a suspend control mode, and, based on the request, activate the suspend control mode, the suspend control mode including adjusting the inlet valve and the exhaust valve, and suspending control of the inlet valve and the exhaust valve.

2. (canceled)

3. The pilot device of claim 1, wherein the request is received when a leak test is to be performed or a sensor of the fluid regulator assembly is to be calibrated.

4. The pilot device of claim 1, wherein the on-board controller is configured to activate the suspend control mode, the suspend control mode including closing the inlet valve and the exhaust valve and suspending control of the closed inlet valve and the closed exhaust valve.

5. The pilot device of claim 1, wherein the on-board controller is configured to activate the suspend control mode, the suspend control mode including closing the inlet valve and opening the exhaust valve and suspending control of the closed inlet valve and the opened exhaust valve.

6. The pilot device of claim 1, wherein, when the on-board controller suspends control of the inlet valve and the exhaust valve, a value of the controlled pressure output by the outlet port remains constant.

7. The pilot device of claim 6, wherein the on-board controller is operable to maintain the value of the controlled pressure output by the outlet port without the installation of any additional valves.

8-10. (canceled)

11. A fluid flow device comprising:
a regulator;
a pilot device comprising:
an inlet port coupled to a source of supply pressure and having an inlet valve;
an exhaust port having an exhaust valve;
an outlet port configured to output a controlled pressure to the regulator; and
an on-board controller communicatively coupled to the inlet valve and the exhaust valve and operable to control the inlet valve and the exhaust valve to control the pressure delivered to the regulator, the on-board controller including a memory, a processor, and logic stored on the memory; and
a computing device in communication with the pilot device, the computing device configured to generate a request to active a suspend control mode and transmit the request to the pilot device,
wherein the on-board controller is configured to receive the request and activate the suspend control mode based on the request, the suspend control mode comprising adjusting the inlet valve and the exhaust valve, and suspending control of the inlet valve and the exhaust valve.

12-14. (canceled)

15. The fluid flow device of claim 11, wherein the request is received when a leak test is to be performed for the fluid flow device or a sensor of the fluid flow device is to be calibrated.

16. The fluid flow device of claim 11, wherein the on-board controller is configured to activate the suspend control mode, the suspend control mode comprising closing the inlet valve and the exhaust valve, and suspending control of the closed inlet valve and the closed exhaust valve.

17. The fluid flow device of claim 11, wherein the on-board controller is configured to activate the suspend control mode, the suspend control mode comprising closing the inlet valve and opening the exhaust valve, and suspending control of the closed inlet valve and the open exhaust valve.

18. The fluid flow device of claim 11, wherein, when the on-board controller suspends control of the inlet valve and the exhaust valve, a value of the pressure output by the outlet port remains locked.

19. The fluid flow device of claim 18, wherein the on-board controller is configured to maintain the locked value of the pressure output by the outlet port without the installation of any additional valves.

20. The fluid flow device of claim 11, further comprising a feedback pressure sensor configured to periodically sense a pressure at an outlet of the regulator and send a feedback control signal to the on-board controller, the feedback control signal being indicative of the magnitude of the detected pressure, wherein the on-board controller is configured to receive but not respond to the feedback control signal when the suspend control mode is activated.

21. A method of stabilizing pressure in an intelligent regulator assembly comprising a pilot device and a regulator, the pilot device comprising an inlet port coupled to a source of supply pressure and having an inlet valve, an exhaust port having an exhaust valve, an outlet port configured to output a controlled pressure to the regulator, and an on-board controller communicatively coupled to the inlet valve and the exhaust valve, the on-board controller operable to control the inlet valve and the exhaust valve to control the pressure delivered to the regulator, the on-board controller including a memory, a processor, and logic stored on the memory, the method comprising:
receiving, at the on-board controller, a request to activate a suspend control mode; and
activating, via the on-board controller, the suspend control mode, the activating comprising adjusting the inlet valve and the exhaust valve, and suspending control of the inlet valve and the exhaust valve.

22. The method of claim 21, wherein receiving the request comprises receiving the request from a computing device in communication with the pilot device.

23. (canceled)

24. The method of claim 21, wherein the request is received when a leak test is to be performed or a sensor is to be calibrated.

25. The method of claim 21, wherein adjusting the inlet valve and the exhaust valve comprises closing the inlet valve and the exhaust valve.

26. The method of claim 21, wherein adjusting the inlet valve and the exhaust valve comprises closing the inlet valve and opening the exhaust valve.

27. The method of claim 21, wherein the activating comprises activating without installing any additional valves.

28. The method of claim 21, further comprising performing a leak detection test or calibrating a sensor while the suspend control mode is activated.
